(19) United States
(12) Patent Application Publication
(10) Pub. No.: US 2011/0079642 A1
(43) Pub. Date: Apr. 7, 2011

(54) Offline-validator

(75) Inventors: Norbert Miller, Monchengladbach (DE); Wolfgang Flügge, Korschenbroich (DE)

(73) Assignee: SCHEIDT & BACHMANN GMBH, Monchengladbach (DE)

(21) Appl. No.: 12/898,984

(22) Filed: Oct. 6, 2010

(30) Foreign Application Priority Data
Oct. 7, 2009 (EP) 09012705.1

(51) Int. Cl. G06Q 20/00; G06Q 50/00

(52) U.S. Cl. 235/379; 235/380

(57) ABSTRACT

The present invention relates to a method for the preferably cashless processing especially of machine-related transactions using a memory card (4), wherein upon detection of the memory card (4), usage is enabled by a machine (3) which is in communication (2) with a database (5) and/or a processing unit (1) and usage-related transaction data are transmitted from the machine (3) to the database (1) and/or the processing unit (1). It is an object of the invention to further develop a method of the this kind to that extent that the intended function of the machine or smartcard writing/reading device can be achieved independently of an existing communication link between the machine or the smartcard writing/reading device and the local database. As a solution, the invention proposes that the usage-related transaction data are stored on the memory card (4) at least temporarily and the memory card (4) is thus utilized as an information transfer medium.

### CROSS-REFERENCE TO RELATED APPLICATIONS

This application claims the benefit and priority of European Application No. 09012705.1, filed Oct. 7, 2009. The entire disclosure of the above application is incorporated herein by reference.

### BACKGROUND

This section provides background information related to the present disclosure which is not necessarily prior art.

### TECHNICAL FIELD

The present invention relates to a method preferably for cashless processing of machine-related transactions using a memory card, wherein upon detection of a memory card, usage is enabled by a machine which is in communication with a database and/or a processing unit and usage-related transaction data are transmitted from the machine to the database and/or the processing unit.

### Discussion

Methods for cashless processing of machine-related transactions are known in a great number, for instance in public transportation, in the use of public facilities like sports facilities, at events or the like. Many of such methods are carried out using a smartcard. The machine is formed by a smartcard writing/reading device, by means of which a communication of the machine with the smartcard can be established. The machine communicates with a local processing unit that comprises a local database. Usage is billed by means of a central processing unit which is installed remotely from the local processing unit and which has databases holding smartcard-related data. At a transaction, the smartcard writing/reading device of the machine detects the smartcard and transmits usage-related transaction data to the local processing unit which enables the desired usage for instance by memorizing on the smartcard an authorization for use.

Such methods are employed among others in public transportation using the smartcard as an electronic ticket. Accordingly, in public transportation, the smartcard serves as an electronic ticket with which the user of the public transportation system can prove his/her authorization for use.

But the known methods require the machine or the smartcard writing/reading device to communicate with the local processing unit and the database contained in this local processing unit. Only then tariff data can be duly captured, transaction data compiled, buffered in the local database and transmitted to the central database for billing or booking. If there is no communication between the machine or the smartcard writing/reading device and the local processing unit, the intended function of the system is not guaranteed any longer. Consequently, in the case of public transportation, it would be impossible to buy a valid electronic ticket.

Bearing these circumstances in mind, it is an object of the invention to improve a method of the above-described kind to that effect that the intended function of the machine or smartcard writing/reading device can be achieved independently of an existing communication between the machine or smartcard writing/reading device and the local database.

### SUMMARY OF THE INVENTION

As a solution, the invention proposes that the usage-related transaction data are memorized on the memory card at least temporarily and that the memory card is accordingly used as an information transfer medium.

Differently from the prior art, an additional virtual communications link is established by means of the memory card by providing the memory card with the usage-related transaction data and by using the memory card in the manner of a communications link as an information transfer medium, in order to subsequently generate the transaction data at the later use of a machine or smartcard writing/reading device which has a connection for example to a local processing unit including a database. Thus it is not necessarily required for a machine or a smartcard writing/reading device to have a communications link to the processing unit and possibly a database, in order to make a usage-related transaction. If the memory card is used the next time, for instance in a further machine or in a further smartcard writing/reading device or the like, which has an existing communications link to a database and particularly to a local database, the usage-related transaction data stored on the memory card can be transmitted to the processing unit where the data are established and stored with the involvement of the tariff data and can then be transmitted to a preferably central database, in order to allow cashless processing or booking of the transaction. In this case, the memory card is a part of the communications link, because it serves for the transmission of the usage-related transaction data to a database.

The machine preferably is an installation which comprises a smartcard writing/reading device and which serves to communicate with the memory card in order to process a transaction in terms of information and for booking. The machine can additionally comprise further installations, for instance communication installations for communication with the database and/or the processing unit, or it can also comprise installations capable of producing transaction data from data read from the memory card, e.g. a computing system or hardware circuit or the like. Transaction data can be written to the memory card using the smartcard writing/reading device. The machine shall not be understood to be a commercially available ticket machine. Nevertheless, the machine of the invention can be combined with a ticket machine.

The database can be a central database separate from the database of the processing unit, which can be a local database. In this central database, all functions and tasks can be centralized. Preferably, the central database is arranged within a spatially predetermined area. Moreover, the database can also only be a local database. Several local databases can communicate with each other and with a central database. Needless to say, the method of the invention is not limited to machine-related transactions. It can also be employed in transactions which are not machine-related, for instance at a kiosk or at a gas station. The method of the invention is of course particularly suited for the processing of cashless transactions. But it can also be applied to cash payment transactions, in order to allow later printing particularly of receipts, invoices or the like.

A system in which the invention is embodied, comprises a preferably central database storing user-related or usage-related data, particularly a local database holding location-related and system-related data, and a memory card that serves as an information transfer medium. But instead of the central and local databases, also a single database can be provided which can be arranged both locally and centrally. The preferably local processing unit having the local database can communicate with the central database of a central processing unit at least temporarily. Different kinds of machines or smartcard writing/reading devices can be provided, and at least a part of the machines or smartcard writing/reading devices communicate with the processing unit and/or its database. Some machines or smartcard writing/reading devices can be exclusively provided for autonomous operation, which means that the same can at no time communicate with the database or with the processing unit.

The memory card serves for providing a memory for usage-related transaction data assigned to a respective usage, at least if a communications link between the machine or smartcard writing/reading device and a local processing unit including a database does not exist or is impossible. Accordingly, the memory card comprises a memory in which usage-related transaction data can be memorized.

The usage-related transaction data can thus be read from the memory of the memory card at a later time, and the complete transaction data can be established by processing in a processing unit using tariff data from the local database. This can be done for instance, if the memory card is used in a machine or smartcard writing/reading device that communicates with the database or the processing unit at least during usage. The usage-related transaction date stored on the memory card are then read, processed in the local processing unit, which produces new transaction data and transmits the new transaction data to the local database and subsequently to the central database. The respective transactions can then be processed on a cashless basis. The processing of usage-related data from the memory card can also be used for reducing credit amounts which are possibly also stored on the memory card.

Especially if a connection exists between the machine or the smartcard writing/reading device and the processing unit or the database, it can of course be provided that at a machine-related transaction on this machine or on this smartcard writing/reading device that communicates with the local processing unit and the database, the usage-related transaction data are not stored on the memory card, but are instead directly transmitted to the local database,

Moreover, it can be provided that the usage-related transaction data are in any case stored on the memory card, namely independently of whether a communications link exists between the machine or the smartcard writing/reading device and the local database or the processing unit. This is useful for instance if the usage-related transaction data stored on the memory card are regularly not read by the machine or the smartcard writing/reading device, but instead by an additional communication terminal that can be included in the system. The communication terminal can also be a user's personal computer. Moreover, redundancy can be achieved by the usage-related transaction data being available both in the central database and on the memory card.

Furthermore, usage-related transaction data can also be stored only partially on the memory card by storing for instance transaction-identifying data like the transaction number, transaction time, type of usage or the like on the memory card, whereas value-related data like the purchase price, number of the bank account or the like are transmitted only to the database. This can be designed as required.

Especially in the case of trouble with the direct transmission of the usage-related transaction data from the machine or smartcard writing/reading device to the processing unit and/or database, the memory card as information transfer medium is a part of the communications link, the communications link being capable of enabling both a space-related and time-related communication.

The non-existing communications link can be caused for example by an interruption or the like. Moreover, the non-existing communications link can also be due to an autonomous operation of the machine or smartcard writing/reading device, for instance if the machine or smartcard writing/reading device is installed at a remote location where a communications link to a processing unit and/or database can be established or maintained only at high cost. The communications link can be unidirectional or also bidirectional. In a unidirectional communications link, transaction data are transmitted preferably exclusively in the direction from the machine and/or smartcard writing/reading device to the processing unit and/or data base.

The memory card can be formed by a smartcard. But it can also be formed by a swipe card, transponder chip or the like. The memory card is substantially characterized by its design as a mobile and particularly portable small-size unit such as a bank card, credit card, coin, stick, key fob or the like having a memory and an interface for coupling the memory for communication. The memory card thus has a memory which can be designed especially as an electronic data memory, magnetic memory or the like. The memory is accessible via the interface. Corresponding to the physical design of the memory card, the machine or smartcard writing/reading device also includes a tailored interface which in the case of a smartcard can be formed for example exclusively by a smartcard writing/reading device. In a memory card with a magnetic strip, a magnetic head can be instead provided for establishing the communications link.

Transactions and especially machine-based transactions, can for example be the provision of services, but also of goods or the like. Moreover, a machine-based transaction can be the provision of an authorization for use that can be stored for example on the memory card. The authorization for use can serve for using facilities such as public transportation or sports facilities, for seeing events or the like. The interfaces of the memory card and the machine or smartcard writing/reading device can be designed for wired or wireless communication. It can be provided for instance that a communication between the machine or smartcard writing/reading device and the memory card is established as soon as the memory card is within the communication range of the machine or smartcard writing/reading device. Advantageously, the communication between the machine or smartcard writing/reading device and memory card can be automatically established.

The, preferably central, database holds among others smartcard-related data allowing the smartcard to be assigned to usage-related transaction data. For this purpose, the memory card preferably includes an identifier which is stored in the central database. This allows usage-related transaction data to be assigned individually to the respective memory card. It is thus possible to assign a usage-related transaction to a memory card and finally to a card holder, in order to bill the user for the transaction. The cashless billing of a transaction can thus comprise invoicing or debiting to an account of the smartcard user. Transactions not only comprise usage in the form of a provision of services and/or goods, but also providing a user, preferably the owner of the smartcard, with an authorization for use. The authorization for use can thus be stored on the memory card in the form of a code, which can be read form the memory card at any time during the use, for instance for verifying purposes.

It is further proposed that the transaction data stored on the memory card are stored together with an identifier. This makes it possible to easily distinguish transaction data from other data stored on the memory card. Moreover, by this identifier, transaction data can be stored in a section of the memory card which is reserved to transaction data. This section can be formed by a fixed part of the storage, but also by a separate storage. The section can be specifically protected, which clearly impedes manipulations by unauthorized third persons. The identifier can be formed for instance by a special code, by additional data, e.g. identification bits, or the like.

A further development provides that transaction data stored on the memory card are preferably read in time-shift when the memory card is detected by a machine or smartcard writing/reading device that communicates with the processing unit and/or database. In this way, the memory card acts as a part of the communications link by being capable of providing transaction data previously stored on it to a further machine or smartcard writing/reading device that reads and transmits these data from the memory card to the local processing unit and/or data base. Thus the memory card becomes a part of the communications link between the machine or smartcard writing/reading device and the database. Of course, reading can be preformed also on the machine or smartcard writing/reading device which has stored the usage-related transaction data on the memory card, provided that a communications link between the machine or smartcard writing/reading device and the database exists at a next, later communication between the memory card and the machine or smartcard writing/reading device. This can be the case, if for example a disturbance in the communication between the machine or smartcard writing/reading device and the database has been removed.

It can be provided that the user brings his/her memory card into the detection range of a smartcard writing/reading device for reading the transaction data, whereupon the machine or smartcard writing/reading device establishes a communications link to the memory card. Of course, it can be also provided for the user to control the establishment of the communications link between the machine or smartcard writing/reading device and the memory card, for example by actuating an operating button for establishing the communications link. This can serve for reducing the energy consumption of the machine or smartcard writing/reading device by deactivating the transmitting/receiving unit in stand-by periods. Moreover, it can be provided for the smartcard writing/reading device to be automatically activated and deactivated or put in a sleep mode by a signal from the local processing unit. This can additionally reduce the energy consumption and is particularly useful in the case of battery-operated machines or smartcard writing/reading devices.

The transactions stored on the memory card can be deleted upon reading. Thus a storage capacity of a storage required for the transaction data can be kept small.

The process of reading transaction data from the memory card can additionally be protected by particular cryptic methods and also by authorizations, thus making it more difficult for unauthorized third persons to access the transaction data.

The transaction date stored on and read from the memory card can be provided with an identifier. This identifier is different from the aforementioned identifier in that the transaction data are marked so as to be distinguishable from the other transaction data that have already been read. This avoids that transaction data are read several times and thus cause unnecessary communication costs. It can also be provided that data which have been read remain stored on the memory card and are deleted in a separate step at a later time. This identifier is also suitable for this purpose, because the transaction data which are intended to be deleted can be readily distinguished by means of the identifier. This allows the reading and deletion of transaction data from a memory card to be two separate processes that can be carried out one after the other. Accordingly, transaction data that have been read can remain stored on the memory card for the time being and deleted at a later time, for instance on the occasion of a next communication with another machine or smartcard writing/reading device. This further improves data security, because deletion of transaction data takes place only at the time of a subsequent communication with the machine or smartcard writing/reading device. This allows transaction data that have possibly been read or transmitted incorrectly, to be verified in a subsequent communication.

Transaction data stored on the memory card can also be read using a communication terminal. The communication terminal also includes a writing/reading unit capable of establishing a communications link to the memory card. But differently from the machine or smartcard writing/reading device, this communication terminal is not designed for providing the possibility of making transactions such as the machine or the smartcard writing/reading device. The communication terminal merely serves to read data stored on the memory card and transmit these data for instance to the database. In addition, it can be provided for the communication terminal to make the stored transaction data available to the user for his/her information. This can be achieved for example by visually displaying the corresponding transaction data on an optical display such as a monitor or the like. Moreover, it can be provided for printing the transaction data or for issuing slips with the transaction data to the user.

Preferably, reading of transaction data stored on the memory card is done automatically. This can be achieved as soon as the communications link between the memory card and the machine or smartcard writing/reading device or the communication terminal is established. In a wireless communication between the communication terminal or the machine or smartcard writing/reading device and the memory card, it can be provided that automatic reading takes place when the memory card is brought into the communication range of the machine or smartcard writing/reading device or communication terminal. If there are several memory cards within the communication range of the machine or the smartcard writing/reading device or communication terminal, polling can be provided to avoid communication conflicts.

The transaction can be processed on the basis of the transaction data. This is preferably done using the data of the processing unit and/or database. The processing unit can be a central processing unit, which communicates with or can particularly comprise the central database. Of course, the database can be arranged remotely from the center, for instance as a separate installation in the form of local databases or in one or several local processing units. Based on transaction data, billing data can be established for example which allow the transaction to be billed to the user being the owner of the memory card. Billing can be done by debiting a bank account, by invoicing or by deduction from a credit stored on the memory card or the like.

The invention further provides for further processing in a processing unit of data read in time-shift from the memory card using a smartcard writing/reading device, which communicates with a processing unit and/or database.

Furthermore, processed transaction data can be stored in a local database.

One embodiment provides that the processed transaction data are transmitted to a central database.

Moreover, due to the further processing by the smartcard writing/reading device, modified authorization data can be written to the memory card.

### BRIEF DESCRIPTION OF THE DRAWINGS

Further features and advantages will become apparent from the following description of an embodiment. Parts and functions which are identical or substantially identical are identified by the same reference numbers. The attached drawings are merely intended to illustrate the following embodiment.

The drawings described herein are for illustrative purposes only of selected embodiments and not all possible implementations, and are not intended to limit the scope of the present disclosure.

FIG. 1 shows a system for billing the fare of public transportation which is used as an example for carrying out the method of the invention; and

FIG. 2 shows the system according to FIG. 1, in which a communications link between a local database and the smartcard writing/reading device is disturbed.

Corresponding reference numerals indicate corresponding parts throughout the several views of the drawings.

### DETAILED DESCRIPTION OF THE PREFERRED EMBODIMENTS

Example embodiments will now be described more fully with reference to the accompanying drawings.

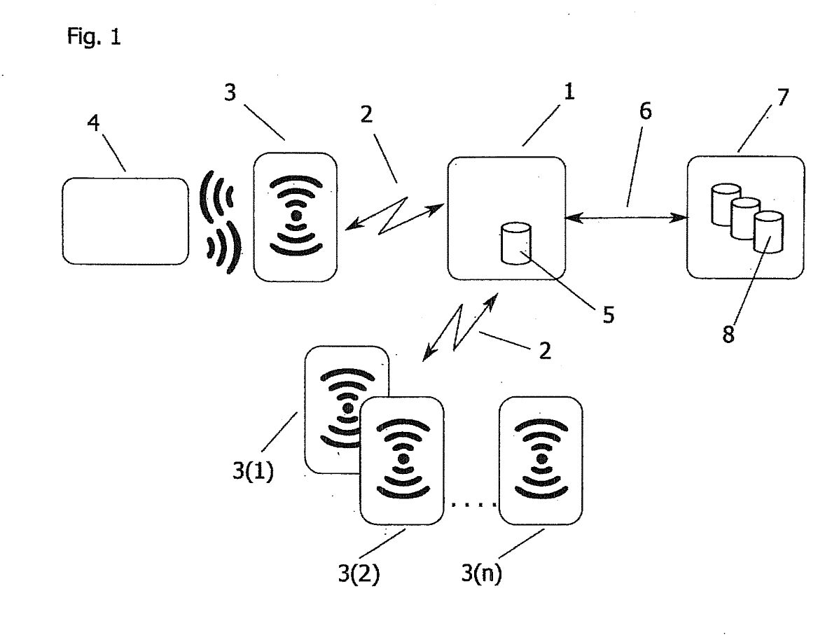

FIG. 1 illustrates an overall system for the cashless processing of machine-based transactions using a memory card 4 and employed in the field of public transportation. This exemplary system comprises a central processing unit 7 having a central database 8. A local processing unit 1, which is also part of the system, is connected to the central database 7 via a bidirectional communications link 6. In addition to the illustrated local processing unit 1, further local processing units (not illustrated) bi-directionally communicate with the central processing unit 7. Each local processing unit 1, which respectively comprises at least one local database 5, has again connected to it a number of machines in the form of smartcard writing/reading devices 3(1) to 3(n) that are part of the system. Each smartcard writing/reading device 3(1) to 3(n) communicates with the local processing unit 1 via a bidirectional communications link 2 in the form of a radio communication. The range of the radio communication in the present embodiment is about 150 m. The range can be adjusted to the local conditions.

The local processing unit 1 including the local database 5 can be integrated in a ticket machine, computer or operator-guided ticket issuing device or the like on site.

In the present case, the bidirectional communications link 2 is designed as a radio communication, thus allowing the smartcard writing/reading devices 3(1) to 3(n) to be arranged with minimum effort in any desired spatial/logical combination. In this connection, power supply of the smartcard writing/reading devices 3(1) to 3(n) by a battery can be expedient. Of course, also a wired bidirectional communications link can be provided instead of or additionally to the radio communication 2. Also the bidirectional communications link 6 to the central processing unit 7 can be designed in a wired and/or wireless fashion.

The local database 5 holds among others tariff data, hot lists, black lists, white lists, action lists and the like. These data make it possible to guarantee safe operation of the system and processing of usage data from captured smartcards 4. For issuing an authorization for use, prior art requires the smartcard writing/reading devices 3(1) to 3(n) to communicate with the local processing unit 1 and the local database 5 included therein and particularly also with these lists, in order that the tariffs can be securely processed and accounted. A comparison of the data in the local database 5 with the data in the central database 8 via the communications link 6, takes place independently of this. Also, for performing the intended function, it is not necessary for the communications link 6 to exist constantly and regularly.

The system which is used for carrying out the method of the invention further comprises a memory card, also referred to herein as smartcards. One smartcard 4 among the plurality of smartcards is illustrated in the drawing figures, and in the present embodiment it serves as an electronic ticket for the use of public transportation. The smartcard 4 is provided with an identifier (not further shown) enabling the smartcard 4 to be clearly assigned to a user. The user uses the smartcard 4 as a ticket if he/she intends to use public transportation. The smartcard 4 further comprises a storage section (not further shown) for storing an authorization for use that can be memorized on the smartcard 4 using smartcard writing/reading devices 3(1) to 3(n).

It is provided for this purpose that the communications link between the smartcard 4 and the smartcard writing/reading device 3 is established by a near radio communication and that the smartcard writing/reading device 3 comprises a detection range. The user brings the smartcard 4 into the detection range so that the smartcard writing/reading device 3 can bi-directionally communicate with the smartcard 4. Alternatively, also an insertion slot can be provided so that the smartcard 4 can be moved to a defined position with respect to the smartcard writing/reading device 3. Of course, also a contact-type communications link can be provided, for instance by providing a contact panel on the smartcard 4, which contact panel upon introduction in the introduction slot (not further shown) of the smartcard writing/reading device 3 is contacted by corresponding springs of the smartcard writing/reading device 3 and in this way establishes a wired communications link to the smartcard 4.

To acquire an authorization for use of the public transportation, the user brings his/her smartcard 4 into the detection range of the smartcard writing/reading device 3. The smartcard writing/reading device 3 identifies the smartcard 4 and automatically establishes a communications link to the smartcard 4. In a selection menu (not further shown), which is displayed on a monitor (not further shown) of the machine or smartcard writing/reading device 3, the user can select a destination via an inputting device (not illustrated) in the form of a keyboard of the machine, and the smartcard writing/reading device 3 writes the respective authorization for use into the corresponding storage section of the smartcard 4. Alternatively, the authorization for use can be generated automatically in dependence of the position of the smartcard writing/reading device 3 or the local processing unit 1 and/or the previous transactions. In the present case, the authorization for use is stored in a coded fashion in a separate area of the storage section of the smartcard 4 and serves as evidence of a valid ticket during the use of the public transportation by the user. If necessary, the authorization for use can be read from the smartcard and verified for validity by a ticket inspector who uses a ticket control device or the like. In the present case, the authorization for use itself is formed by a binary digital code that is provided with a time stamp of issuance of the code. To this end, the smartcard writing/reading device 3 includes a clock providing the actual time. This makes sure that the authorization for use cannot be used in any desired way, but only for a predetermined time range which is deemed reasonable for the intended use of the public transportation.

But prior to storing the authorization for use in the smartcard 4 using the smartcard writing/reading device 3, corresponding usage-related transaction data are transmitted from the smartcard writing/reading device 3 to the local processing unit 1 including the database 5 via the communications link 2. From these usage-related transaction data, the local processing unit 1 generates associated transaction data which are returned to the smartcard writing/reading device 3 via the communications link 2. The smartcard writing/reading device 3 stores the authorization for use on the smartcard 4 and outputs an optical and/or acoustical signal or display message to the user of the smartcard 4 so that the user can be sure that the transaction is completed and that he can commence traveling by public transportation.

To guarantee fast processing, only data held in the local database 5 are used to generate the authorization for use. The local database 5 stores the usage-related transaction data and subsequently transmits these data to the central database 8, which then updates the usage data of the smartcard 4. The usage-related transaction data comprise the identification of the smartcard 4. In the present case, it can be provided for the central database 8 to debit a current bank account of the user of the smartcard 4 using the usage-related transaction data.

It can be provided that as soon as the bank account has been successfully debited, the smartcard writing/reading device 3 is instructed via the communications link 2 to store the authorization for use on the smartcard 4. Then the smartcard writing/reading device 3 immediately stores the authorization for use on the smartcard 4 and outputs an optical and/or acoustical signal, which informs the user of the smartcard 4 that the authorization for use is stored on the smartcard 4.

The user removes his/her smartcard 4 from the introduction slot of the smartcard writing/reading device 3 and commences traveling by public transportation.

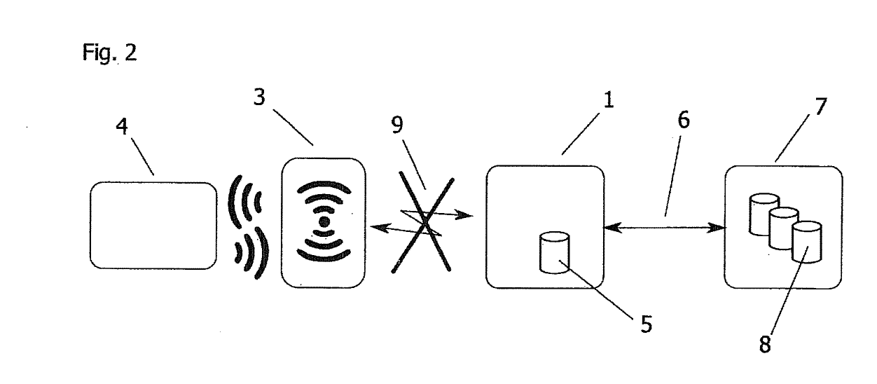

FIG. 2 shows the system according to FIG. 1, however, with the radio communication 2 being disturbed. In the present case, the disturbed radio communication is identified by reference number 9 in FIG. 2. In prior art systems, a fault report appears in this case on the smartcard writing/reading device 3 and is usually optically indicated to the potential user by a warning light. In this case, it is not possible for the users to acquire an authorization for use.

This is where the invention works, which makes it possible to acquire an authorization for use even though the communications link 9 is disturbed. For this purpose, the smartcard 4 includes a storage section (not further shown) which is separate from the storage section for the authorizations for use and in which transaction data can be stored for later accounting. Accordingly, the smartcard 4 serves as an information transport medium and hence as a part (not further shown) of a communications link 9 (not further shown) to the central data base 8.

As previously explained with reference to FIG. 1, the user brings its smartcard 4 into the detection range of the smartcard writing/reading device 3, whereupon the smartcard 4 is detected and a communications link to the smartcard 4 established. The smartcard writing/reading device 3 writes usage-related transaction data to the dedicated storage section of the smartcard 4 while simultaneously storing an authorization for use in the storage section provided for the authorizations for use. After storing the data on the smartcard 4, the smartcard writing/reading device 3 optically indicates the successful transaction to the user by means of a lamp. The user removes his/her smartcard from the detection range of the smartcard writing/reading device 3 and commences his/her ride as usual.

This embodiment did not allow the usage-related transaction data to be transmitted to and processed in the local processing unit 1 including its local database 5. Thus the usage of the smartcard 4 could not initially be accounted in the central database 8.

In the following usage on a smartcard writing/reading device 3 having a communications link 2 with the local database 5 as shown in FIG. 1, the smartcard writing/reading device 3 checks whether corresponding data are stored in the storage section provided for usage-related transaction data and reads these data if necessary. The usage-related transaction data that have been read are then transmitted via the communications link 2 to the local processing unit 1 and are processed using the data from the data base 5, thus producing valid and complete transaction data which are stored in the database 5 and/or are subsequently transmitted to the central database 8, which performs the corresponding accounting operations as previously described with reference to FIG. 1.

Then the user can purchase a further authorization for use of the public transportation in the manner described with reference to FIG. 1.

Of course, it can also be provided that individual smartcard writing/reading devices 3 can be operated completely autonomously. It is possible for example to store plural usage-related transaction data on the smartcard 4 and to read these data at a later time, in order to enable accounting. This embodiment allows smartcard writing/reading devices to be, particularly subsequently, installed in places where a communications link to a database, particularly to the local or central database, is possible only with considerable efforts, which would question the cost effectiveness of the method. The possibility offered by the invention, namely using the smartcard itself as a part of the communications link by its utilization as an information transport medium, allows a considerable improvement of the reliability and flexibility of memory card-based cashless processing of machine-related transactions. Moreover, the efficiency can be increased by only a limited number of smartcard writing/reading devices being in communication with the processing unit and/or the database. This not only reduces material costs, but also energy consumption, especially the consumption of energy needed for the operation of the communications link. Moreover, fault security can be further improved with the invention, because in the case of a disturbed communications link between the smartcard writing/reading device 3 and the local database 5, an alternative operation can be made possible by the smartcard writing/reading device 3 switching to an autonomous mode of operation using the memory card 4 as an information transfer medium. Accordingly, the memory card 4 in connection with a later reading of the usage-related transaction data represents an alternative communications link to the database.

A particularly simple embodiment provides that the memory card includes a common storage for authorizations for use and usage-related transaction data. To easily find the usage-related transaction data at the time of reading, the same can be marked during writing to the memory card 4. In this embodiment, the identifier consists of an additional bit series that is attached to the transaction data. Accordingly, during reading the data from the memory card, these data can be identified as stored usage-related transaction data and can be supplied to separate processing.

The transaction data stored on the memory card are read when the memory card 4 is detected by a smartcard writing/reading device 3 that communicates with the local database 5. This can take place for example only after a random number of preceding transactions. The storage of the memory card 4 has to be appropriately designed.

The transaction data stored on the memory card can be deleted at the time of reading. This makes storage space for further and future usage-related transactions available.

But it can also be generally provided that the transaction data stored on and read from the memory card are provided with an additional identifier. Like the abovementioned identifier, this additional identifier can consist of an additional bit series which is attached to the transaction data instead of their deletion. These read transaction data together with the additional identifier accordingly remain stored in the storage of the memory card for the time being. Only if a next reading of transaction data from the memory card takes place, the transaction data which already comprise the additional identifier are deleted. Thus is its possible to keep the transaction data redundantly available both in the database and on the memory card, at least temporarily. This is an advantage among others if the communications link between the machine or the smartcard writing/reading device and the processing unit or the database is of bad quality, so that a data loss is to be expected. Then there is the possibility, during a next communication between the memory card and the machine or the smartcard writing/reading device, to verify individual usage-related transaction data by a repeated reading. Of course, it can also be provided that the user himself/herself has control over the deletion of usage-related transaction data on the memory card. Accordingly, it can be provided that the user determines if and when transaction data are deleted. The additional identifier of read transaction data can also serve this purpose. That is to say, it can be made sure that the user can delete only those transaction data that have already been read from the storage.

For reading the memory card, also a simple communication terminal can be used, for instance also a computer such as a commercially used personal computer. It is merely required that the communication terminal communicates with the processing unit or the database and can thus transmit transaction data read from the memory card to the processing unit or the database. Accordingly, usage-related transaction data can also be read by the user himself/herself, for instance on his/her private personal computer. In this case for example, the smartcard writing/reading devices 3 can all be operated preferably autonomously, i.e. without a communications link to the data base.

Usage is accounted on the basis of the transaction data by charging the user for the usage using the data available in the database. This can be achieved by deducting from a user's credit in the database a figure which corresponds to the usage. Alternatively or additionally, it can be provided that a user's account is debited or a deduction is made from a credit on the smartcard 4.

Accordingly, the invention allows transactions to be retraced despite a lacking communication between the machine or smartcard writing/reading devices and a processing unit or database. Failed databases or communications links to databases do not have any effect on the operation of the system whose user can still use his/her smartcard as intended. This avoids that a user of public transportation unintentionally evades the fare due to a failure of the device for purchasing the authorization for use at site. Moreover, additional machines can be provided, which operate autonomously, which is an advantage especially under complex spatial conditions or at a short-term high user frequency. Moreover, the flexibility of installation of autonomously operating machines is an advantage for example in coping with peak periods or events.

The embodiment shown in the drawing figures merely serves to illustrate the invention, without in any way limiting the invention.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed:

1. A method for the cashless processing especially of machine-related transactions using a memory card (4), wherein upon detection of the memory card (4), usage is enabled by a machine (3) which is in communication (2) with a database (5) and/or a processing unit and usage-related transaction data are transmitted from the machine (3) to the database (1) and/or the processing unit (1), comprising wherein:
a virtual communications link is established by storing the usage-related transaction data on the memory card (4) at least temporarily and thus utilizing the memory card (4) as a part of the virtual communications link from the machine (3) to the database (1) and/or processing unit, wherein at a later usage of a machine (3) which is in communication (2) with the database (1) and/or the processing unit, the usage-related transaction data stored on the memory card (4) are read and the complete transaction data established using the memory card (4).

2. The method according to claim 1, wherein the transaction data stored on the memory card (4) are stored with an identifier.

3. The method according to claim 1, wherein transaction data stored on the memory card (4) are read in time-shift when the memory card (4) is detected by a machine (3) which is in communication (2) with the processing unit (1) and/or the database (5).

4. The method according to claim 3, wherein the data read in time-shift from the memory card using a smartcard writing/reading device (3) which is in communication (2) with a processing unit (1) and/or a database (5), are further processed by a processing unit (1).

5. The method according to claim 4, wherein the processed transaction data are stored in a local database (5).

6. Method according to claim 5, characterized in that the processed transaction data are transmitted to a central database (8).

7. The method according to claim 6, wherein due to processing, modified authorization data are written to the memory card (4) via the smartcard writing/reading device (3).

8. The method according to claim 1, wherein the transaction data stored on the memory card (4) are deleted at the time of reading.

9. The method according to claim 2 wherein reading of the transaction data stored on the memory card (4) is controlled by means of the identifier.

10. The method according to claim 1 wherein the transaction data stored on and read from the memory card (4) are provided with an identifier.

11. The method according to claim 1 wherein the transaction data stored on the memory card (4) are read using a communication terminal.

12. The method according to claim 1 wherein reading of the transaction data stored on the memory card (4) takes place automatically.

13. The method according to claim 1 wherein processing of a usage takes place on the basis of the transaction data.

14. A cashless method of processing transaction data comprising:
a) providing a memory card with a storage section in which transaction information is written to and read from by a writing/reading device that normally communicates with a local processing unit that, in turn, communicates with a central database;
b) if communication is not established between a first writing/reading device at a first location and the local processing unit, then writing transaction information into the memory card with the first writing/reading device;
c) transporting the card by a user away from the first location with the transaction information associated with the first location stored in the memory card; and
d) thereafter, reading the transaction data from the memory card by a writing/reading device that has communication established with a local processing unit.

15. The method of claim 14 wherein the memory card is used in a fare-based transportation system, with the writing/reading device storing in step b) authorization to use data as well as transaction data in the storage section of the memory card so that the user can use the transportation system despite inoperability of the communication between the writing/reading device and the local processing unit at the first location.

16. The method of claim 14 wherein the transaction data is erased from the memory card in step d).

17. The method of claim 16 wherein an identifier is associated with the transaction data.

18. The method of claim 17 wherein the identifier determines whether or not the transaction data is erased in step d).

19. The method of claim 15 wherein the local processing unit communicates with the central database after step d) for debiting a user's account based on the transaction data that was stored in the memory card.
